(19) United States
(12) Patent Application Publication
(10) Pub. No.: US 2018/0105458 A1
(43) Pub. Date: Apr. 19, 2018

(54) METHODS AND SYSTEMS FOR PROCESSING GLASS RIBBONS AND GLASS RIBBONS FORMED THEREBY

(71) Applicant: CORNING INCORPORATED, CORNING, NY (US)

(72) Inventors: Ching-Kee Chien, Horseheads, NY (US); Kiat Chyai Kang, Painted Post, NY (US); Sue Camille Lewis, Webster, NY (US)

(21) Appl. No.: 15/557,331

(22) PCT Filed: Mar. 10, 2016
(86) PCT No.: PCT/US16/21645

§ 371 Date: Sep. 11, 2017

Related U.S. Application Data
(60) Provisional application No. 62/132,841, filed on Mar. 13, 2015.

(51) Int. Cl. C03C 17/34; C03C 17/30; B65H 18/10

(52) U.S. Cl. CPC C03C 17/3405; B65H 23/1806; B65H 18/103; C03C 17/30

(57) ABSTRACT

A method includes applying a coupling agent solution to a major surface of a continuously moving glass ribbon to form a coupling agent coated region of the glass ribbon. The glass ribbon is a flexible glass ribbon having a thickness of at most about 300 μm. The method includes heating the coupling agent coated region of the glass ribbon to form a coupling agent treated region of the glass ribbon and winding the glass ribbon onto a collection roll. A glass ribbon has a thickness of at most about 300 μm and a major surface. At least a portion of the major surface includes a coupling agent treated region. Upon forming a polymeric layer on the coupling agent treated region at least five months after forming the coupling agent treated region, the polymeric layer has a peel force of at least 200 gf/in.

This application claims the benefit of priority to U.S. Application No. 62/132,841, filed on Mar. 13, 2015, the content of which is incorporated herein by reference in its entirety.

### BACKGROUND

### 1. Field

This disclosure relates to glass ribbons, and more particularly to methods and systems for continuous processing of glass ribbons.

### 2. Technical Background

Flexible glass substrates can be used in a variety of applications including, for example, display devices (e.g., thin, flexible, and/or curved display devices), touch sensors, photovoltaic devices, and optical products. Such substrates can be processed as individual sheets or as a long ribbons that can be wound to form spools of glass. When the substrates are processed as long ribbons, the substrates typically are passed over various rollers or other mechanisms that support and guide the substrates through various processing apparatus. In some processes, coatings can be applied to the surfaces of the glass substrates. However, the adhesion between the coatings and the glass substrates may not be sufficiently strong to remain intact during processing of the glass substrates or handling of the glass substrates following processing. For example, contact between rollers during processing can cause the coatings to separate from the glass substrates.

### SUMMARY

Disclosed herein are methods for surface treating a flexible glass ribbon with a coupling agent and rolled glass ribbons formed thereby.

Disclosed herein is a method comprising applying a coupling agent solution to a major surface of a continuously moving glass ribbon to form a coupling agent coated region of the glass ribbon. The glass ribbon comprises a flexible glass ribbon having a thickness of at most about 300 μm. The method comprises heating the coupling agent coated region of the glass ribbon to form a coupling agent treated region of the glass ribbon and winding the glass ribbon onto a collection roll.

Disclosed herein is a method comprising passing a glass ribbon continuously through a coating unit to apply a coupling agent solution to a major surface of the glass ribbon and form a coupling agent coated region of the glass ribbon. The glass ribbon comprises a flexible glass ribbon having a thickness of at most about 300 μm. The method comprises passing the glass ribbon through a heating unit to heat the coupling agent coated region and form a coupling agent treated region of the glass ribbon and winding the glass ribbon onto a collection roll.

Disclosed herein is a glass ribbon comprising a thickness of at most about 300 μm and a major surface. At least a portion of the major surface comprises a coupling agent treated region. Upon forming a polymeric layer on the coupling agent treated region at least five months after forming the coupling agent treated region, the polymeric layer comprises a peel force of at least 200 gf/in.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of one exemplary embodiment of a glass ribbon.

FIG. 2 is a longitudinal cross-sectional view of one exemplary embodiment of the glass ribbon of FIG. 1 wound into a roll.

FIG. 3 is a schematic illustration of one exemplary embodiment of a system that can be used to form and treat a glass ribbon.

FIG. 4 is a schematic illustration of one exemplary embodiment of a system that can be used to treat a glass ribbon.

FIG. 5 is a schematic illustration of one exemplary embodiment of a system that can be used to treat and process a glass ribbon.

FIG. 6 is a graphical illustration of one exemplary embodiment of a peel force of a UV curable coating as a function of silane concentration.

FIG. 7 is a graphical illustration of one exemplary embodiments of a peel force of a UV curable coating as a function of storage time.

FIG. 8 is a graphical illustration comparing peel forces of various samples of UV curable coatings on untreated and treated glass plates.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

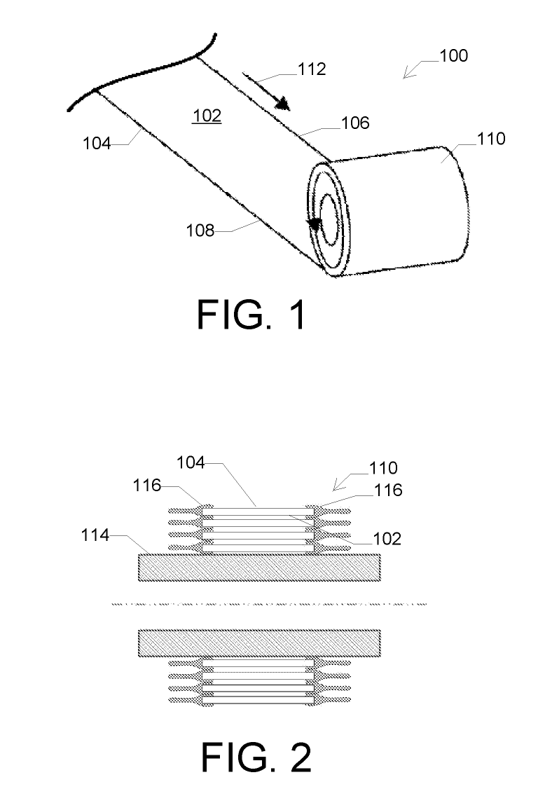

FIG. 1 is a perspective view of one exemplary embodiment of a glass ribbon 100. Glass ribbon 100 has a thickness, a width, and a length. The thickness is less than the width, and the width is less than the length. Thus, the thickness is the smallest dimension of glass ribbon 100, and the length is the largest dimension of the glass ribbon. Glass ribbon 100 comprises a first major surface 102 and a second major surface 104 opposite the first major surface. The distance between first major surface 102 and second major surface 104 defines the thickness of glass ribbon 100. In some embodiments, the thickness of glass ribbon 100 is at most about 300 μm, at most about 200 μm, at most about 150 μm, or at most about 100 μm. Additionally, or alternatively, the thickness of glass ribbon 100 is at least about 10 μm, at least about 20 μm, or at least about 50 μm. Glass ribbon 100 comprises a first edge 106 and a second edge 108 opposite the first edge. The distance between first edge 106 and second edge 108 defines the width of glass ribbon 100. In some embodiments, the width of glass ribbon 100 is at least 2 orders of magnitude (i.e., at least 100 times) greater than the thickness of the glass ribbon. Additionally, or alternatively, the length of glass ribbon 100 is at least 1 order of magnitude (i.e., at least 10 times) greater than the width of the glass ribbon. In some embodiments, glass ribbon 100 comprises a flexible glass ribbon that is capable of being wound into a roll. For example, FIG. 1 shows glass ribbon 100 being wound into a roll 110.

In some embodiments, glass ribbon 100 is processed in a continuous manner. For example, glass ribbon 100 comprises a continuously moving glass ribbon. A central region of continuously moving glass ribbon 100 moves continuously in a longitudinal direction 112 (e.g., toward roll 110) through one or more processing units. Such continuous movement of the glass ribbon can enable processing of the central region of the glass ribbon (e.g., prior to winding the central region into the roll) by the one or more processing units. Such processing can include, for example, segmenting, grinding, polishing, cleaning, treating (e.g., surface treating), or depositing a coating (e.g., a resin, an ink, an adhesive, a paint, or another suitable organic or inorganic composition) or component (e.g., a transistor, an electroluminescent layer, or another suitable component) on glass ribbon 100. In some embodiments, after processing, the central region of glass ribbon 100 is wound into roll 110. In some embodiments, the glass ribbon is fed from a roll as described herein. Thus, the processing in a continuous manner comprises roll-to-roll processing. In other embodiments, the glass ribbon is fed from a glass forming unit.

FIG. 2 is a longitudinal cross-sectional view of one exemplary embodiment of glass ribbon 100 wound into roll 110, taken along a longitudinal axis of the roll. In some embodiments, roll 110 comprises a core 114 around which glass ribbon 100 is wound. For example, core 114 comprises a cylindrical spool around which glass ribbon 100 is wound. In other embodiments, the core is omitted (e.g., by winding the glass ribbon around itself or by removing the core after winding the glass ribbon). Roll 110 comprises a plurality of windings. Each winding can be formed by wrapping glass ribbon 100 one revolution around roll 110. In some embodiments, the first major surface and the second major surface of the glass ribbon contact one another at an interface between directly adjacent windings. In other embodiments, adjacent windings are spaced from one another so that the first major surface and the second major surface of the glass ribbon do not contact one another at the interface between directly adjacent windings. For example, in some embodiments, roll 110 is substantially free of contact between first major surface 102 and second major surface 104 as shown in FIG. 2.

In the embodiment shown in FIG. 2, glass ribbon 100 comprises edge tabs 116 applied to opposing first edge 106 and second edge 108. Edge tabs 116 can be configured as described in US Patent Application Publication No. 2011/0023548, which is incorporated by reference herein in its entirety. For example, edge tabs 116 comprise a coating applied to first major surface 102 and second major surface 104 and extending inward from each edge of glass ribbon 100. Thus, a first edge region of glass ribbon 100 adjacent to first edge 106 and a second edge region of the glass ribbon adjacent to second edge 108 are covered by edge tabs 116, and an intermediate region disposed between the first edge region and the second edge region is uncovered by the edge tabs. The coating comprises a polymeric material or another suitable material. The edge tabs can help to space adjacent windings from one another to avoid contact between major surfaces of the glass ribbon in the roll. Thus, the roll comprises a gap between adjacent windings. Such spacing can help to avoid damaging the major surfaces (e.g., at the central regions) and/or blocking of the glass ribbon wound into the roll.

Although FIG. 2 shows edge tabs 116 applied to both first major surface 102 and second major surface 104 and to both first edge 106 and second edge 108, other embodiments are included in this disclosure. In other embodiments, the edge tabs comprise a coating applied to one of the first major surface or the second major surface. Additionally, or alternatively, the edge tabs extend inward from one edge of the glass ribbon such that the edge tabs are disposed on one of the first edge region or the second edge region.

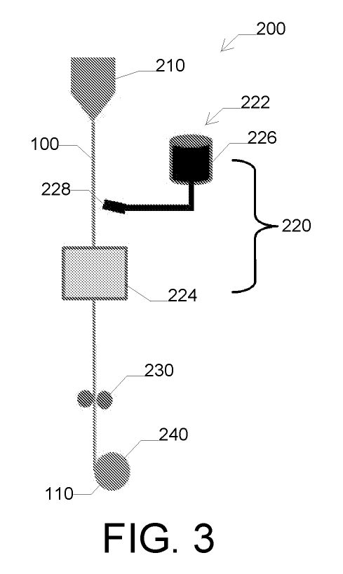

FIG. 3 is a schematic illustration of one exemplary embodiment of a system 200 that can be used to form and treat a glass ribbon. An exemplary embodiment of a method for forming and treating the glass ribbon will be described with reference to FIG. 3. In some embodiments, system 200 comprises a forming unit 210 to form glass ribbon 100. In such embodiments, the method comprises forming glass ribbon 100. Glass ribbon 100 is formed using a downdraw process, a slot draw process, a float process, an updraw process, or another suitable forming process. For example, glass ribbon 100 is formed using a fusion draw process as shown in FIG. 3. In some embodiments, glass ribbon 100 moves continuously away from forming unit 210 in the longitudinal direction. Thus, glass ribbon 100 is a continuously moving glass ribbon.

In some embodiments, system 200 comprises a surface treating unit 220 that can be disposed downstream of forming unit 210 to treat a surface of glass ribbon 100. In the embodiment shown in FIG. 3, surface treating unit 220 comprises a coating unit 222 and a drying unit 224. Coating unit 222 is configured to apply a coupling agent solution to a major surface (e.g., first major surface 102 and/or second major surface 104) of glass ribbon 100 to form a coupling agent coated region of the glass ribbon. In such embodiments, the method comprises applying the coupling agent solution to the major surface of glass ribbon 100 to form the coupling agent coated region of the glass ribbon. For example, glass ribbon 100 is passed continuously through coating unit 222 to apply the coupling agent solution to the major surface of the glass ribbon and form the coupling agent coated region of the glass ribbon. In some embodiments, the method is free of a cleaning step prior to the applying step. For example, the glass surface can be treated with the coupling agent solution as formed without an additional cleaning or washing step. Applying the coupling agent solution comprises slot die coating, spray coating, dip coating, vapor deposition, wiping, doctoring, or another suitable coating process. In the embodiment shown in FIG. 3, coating unit 222 comprises a vessel 226 and a spraying unit 228. Vessel 226 comprises a tank, a tote, a barrel, or another suitable vessel to contain the coupling agent solution. Spraying unit 228 comprises a nozzle, a jet, or another suitable spraying device to apply the coupling agent solution to glass ribbon 100. The coupling agent solution is fed from vessel 226 to spraying unit 228 and applied to glass sheet 100 using a spray coating process. In some embodiments, the applying step comprises applying a layer of the coupling agent solution to the major surface of the continuously moving glass ribbon, and a wet thickness (e.g., prior to drying) of the layer is about 100 μm to about 200 μm. Additionally, or alternatively, a dry thickness (e.g., after drying) of the layer is about 0.01 μm to about 2 μm or 0.01 μm to about 0.1 μm.

Drying unit 224 is configured to heat the coupling agent coated region of glass ribbon 100 to form a coupling agent treated region of the glass ribbon. In such embodiments, the method comprises heating the coupling agent coated region of glass ribbon 100 to form a coupling agent treated region of the glass ribbon. For example, glass ribbon 100 is passed continuously through drying unit 224 to heat the coupling agent coated region and form a coupling agent treated region of the glass ribbon. Heating the coupling agent coated region can drive off at least a portion of the coupling agent solution (e.g., by evaporating at least a portion of a solvent component) to form the coupling agent treated region. Additionally, or alternatively, heating the coupling agent coated region can activate the coupling agent solution (e.g., a silane component) to form the coupling agent treated region. Drying unit 224 comprises a furnace, an oven, a lehr, or another suitable heating unit. Additionally, or alternatively, drying unit 224 heats glass ribbon 100 by convection, radiation, conduction, or another suitable heating process.

In some embodiments, system 200 comprises a spacer application unit 230 that can be disposed downstream of forming unit 210 and/or surface treating unit 220 to apply a spacer to glass ribbon 100. In such embodiments, the method comprises applying a spacer to at least one major surface of glass ribbon 100. In some embodiments, the spacer comprises one or more edge tabs 116. Thus, the method comprises applying an edge tab to an edge region of at least one major surface of glass ribbon 100. In other embodiments, the spacer comprises an interleaf material that is applied to a major surface of the glass ribbon. The interleaf material comprises foam, paper, plastic, or another suitable interleaf material. The interleaf material can be adhered to the glass ribbon (e.g., using an adhesive, static pinning, or another suitable adhesion process) or non-adhered to the glass ribbon. The spacer can help to space adjacent windings from one another when the glass ribbon is wound onto the roll as described herein.

In some embodiments, system 200 comprises a winding unit 240 that can be disposed downstream of forming unit 210, surface treating unit 220, and/or spacer application unit 230 to wind glass ribbon 100 into roll 110. In such embodiments, the method comprises winding glass ribbon 100 onto a collection roll. In some embodiments, the winding step is performed subsequent to the heating step. Thus, winding unit 240 is disposed downstream of drying unit 224 In other embodiments, the winding step is performed prior to the heating step. Thus, the winding unit is disposed between the coating unit and the drying unit. In such embodiments, the glass ribbon wound onto the roll can be placed into the drying unit as part of a batch process as opposed to passing the glass ribbon continuously through the drying unit.

The glass ribbon can be stored on the roll for further processing. Thus, the glass ribbon can be formed, surface treated, and then wound onto a spool that can be used as a supply spool in a roll-to-roll process such as a coating, printing, laminating, or other process. The surface treating unit can modify the surface of the glass ribbon for such further processing. For example, the modified surface of the glass ribbon can enable more effective coating of the glass ribbon (e.g., with a polymeric material) compared to an unmodified surface as described herein.

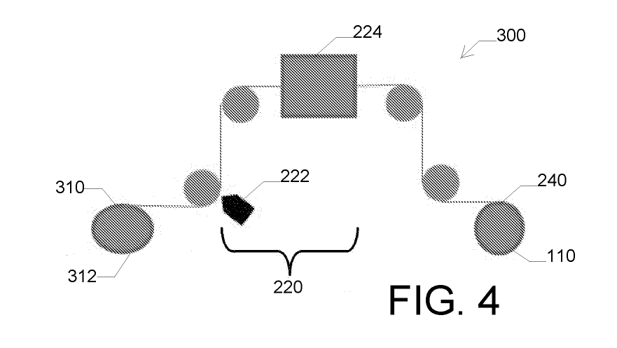

FIG. 4 is a schematic illustration of one exemplary embodiment of a system 300 that can be used to treat a glass ribbon. System 300 is similar to system 200 described herein with reference to FIG. 3. For example, system 300 comprises surface treating unit 220 (comprising coating unit 222 and drying unit 224) and winding unit 240 that can be disposed downstream of the surface treating unit. An exemplary embodiment of a method for treating the glass ribbon will be described with reference to FIG. 4. The method is similar to the method described herein with reference to FIG. 3. Accordingly, some of the method steps are not repeated. In some embodiments, system 300 comprises a glass feeding unit 310 as shown in FIG. 4. Glass feeding unit 310 is disposed upstream of surface treating unit 220 to supply glass ribbon 100 to the surface treating unit. In such embodiments, the method comprises unwinding glass ribbon 100 from a supply roll 312. For example, the glass ribbon can be formed using a suitable glass forming process and wound onto the supply roll. The glass ribbon then can be unwound from the supply roll, fed through the surface treating unit, and rewound onto the collection roll. Thus, the glass forming process and the glass treating process can be separated from one another (e.g., to be performed at different times and/or in different locations). The glass ribbon can be treated in an off-line roll-to-roll process and then used in a subsequent roll-to-roll process such as a coating, printing, laminating, or other process.

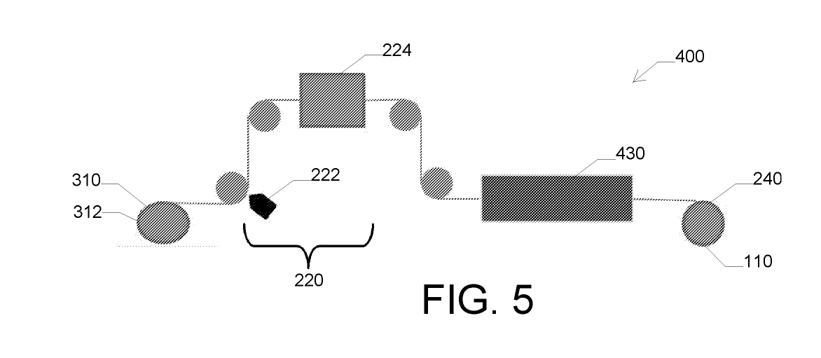

FIG. 5 is a schematic illustration of an exemplary embodiment of a system 400 that can be used to treat and process a glass ribbon. System 400 is similar to system 300 described herein with reference to FIG. 4. For example, system 400 comprises glass feeding unit 310, surface treating unit 220 (comprising coating unit 222 and drying unit 224) that can be disposed downstream of the glass feeding unit, and winding unit 240 that can be disposed downstream of the glass feeding unit and/or the surface treating unit. An exemplary embodiment of a method for treating the glass ribbon will be described with reference to FIG. 5. The method is similar to the methods described herein with reference to FIGS. 3-4. Accordingly, some of the method steps are not repeated. In some embodiments, system 400 comprises a processing unit 430 as shown in FIG. 5. Processing unit 430 is disposed downstream of glass feeding unit 310 and surface treating unit 220 to process the coupling agent treated region of glass ribbon 100. In some embodiments, processing unit 430 comprises a plurality of processing units disposed in parallel or in series. Processing the coupling agent coated region comprises segmenting, grinding, polishing, cleaning, treating (e.g., surface treating), depositing a coating (e.g., a resin, an ink, an adhesive, a paint, or another suitable organic or inorganic component) or component (e.g., a transistor, an electroluminescent layer, or another suitable component) on, and/or patterning (e.g., using an embossing, lithographic, engraving, etching, or other suitable patterning process) the coupling agent treated region of glass ribbon 100. For example, in some embodiments, the method comprises applying a polymeric layer to the coupling agent coated region of glass ribbon 100. For example, the polymeric layer comprises a resin, an ink, an adhesive, a paint, or another suitable organic or inorganic component. Applying the polymeric layer to the coupling agent coated region can enable improved adhesion between the polymeric layer and the glass ribbon relative to applying the polymeric layer to the glass ribbon without first surface treating the glass ribbon. For example, in some embodiments, a peel force of the polymeric layer is at least about 200 g/in. Additionally, or alternatively, the polymeric layer comprises a peel force of at least 200 g/in five months after forming the polymeric layer on the glass ribbon. In some embodiments, the glass ribbon is further processed after applying the polymeric layer. For example, the polymeric layer can be subjected to a patterning process after application to the glass ribbon. The improved adhesion between the polymeric layer and the glass ribbon can help to retain the polymeric layer on the glass ribbon and/or prevent the polymeric layer from sticking to processing units during such further processing.

In some embodiments, the glass ribbon can be formed using a suitable glass forming process and wound onto the supply roll. The glass ribbon then can be unwound from the supply roll, fed through the surface treating unit and the processing unit, and rewound onto the collection roll. Thus, the glass forming process and the glass treating/processing can be separated from one another (e.g., to be performed at different times and/or in different locations). The glass ribbon can be treated in-line with, for example, a coating process, a printing process, a laminating process, or another suitable process as part of a continuous, roll-to-roll process.

In various embodiments, the glass forming unit, the glass feeding unit, the surface treating unit, the processing unit, and/or the winding unit can comprise one or more glass handling devices (e.g., rollers, air bearings, or other suitable handling devices). The handling devices can be configured, for example, to guide, support, and/or tension the glass ribbon as it moves continuously through the system.

A thin glass ribbon or web can be processed at high speed using a continuous process as described herein. For example, the thin glass ribbon or web can be processed using roll-to-roll spooling, where the glass is dispensed from one roll, passes through manufacturing process steps, and then is spooled onto a second roll. The processing can include coating a resin, an ink, an adhesive, a paint, or another suitable organic or inorganic component on the glass. Adhesion of such coatings to the glass can be problematic. In particular, such coatings should have a relatively high adhesion to the glass to survive through the coating process and any downstream processes. If the coating does not adhere to the glass with sufficient strength, the glass can break during processing, which can cause downtime in the operation. Additionally, or alternatively, the coating can delaminate during downstream processes and/or during storage.

Silanes, such as organosilanes, can be used as adhesion promoters for glass. In various embodiments, the coupling agent solution comprises a silane component (e.g., an acryloxy silane, a methacryloxy silane, a mercapto silane, a glycidoxy silane, or combinations thereof) and a solvent (e.g., acetone, ethanol, water, or combinations thereof). In some embodiments, the silane component comprises an alkoxysilane. Additionally, or alternatively, the solvent comprises an alcohol. Additionally, or alternatively, the coupling agent solution comprises about 2% silane in an aqueous or organic solvent (e.g., acetone, ethanol, or combinations thereof). In some embodiments, the silane is acidified with a diluted acid (e.g., acetic acid) to activate the silane by hydrolysis.

In some embodiments, applying the coupling agent solution to the major surface of the continuously moving glass ribbon to form the coupling agent coated region of the glass ribbon comprises applying a layer of the coupling agent solution to the major surface of the continuously moving glass ribbon, and a wet thickness of the layer is about 100 μm to about 200 μm.

Heating the coupling agent coated surface can help to remove the solvent component from the coupling agent solution (e.g., by evaporation) and/or activate the silane component of the coupling agent solution to bond to the glass ribbon. In some embodiments, heating the coupling agent coated region of the glass ribbon to form the coupling agent treated region comprises exposing the coupling agent coated region of the glass ribbon to a heating temperature of about 100° C. to about 120° C. for a heating time of about 5 min to about 15 min. In other embodiments, heating the coupling agent coated region of the glass ribbon to form the coupling agent treated region comprises exposing the coupling agent coated region of the glass ribbon to a first heating temperature of about 90° C. to about 110° C. for a first heating time of about 5 s to about 30 s and subsequently exposing the coupling agent coated region of the glass ribbon to a second heating temperature of about 30° C. to about 50° C. for a second heating time of about 45 s to about 90 s.

In some embodiments, the heating is part of a continuous process as described herein. Thus, the heating time can be determined by the size of the drying unit and the speed of the continuously moving glass ribbon. For example, the heating time can be increased by increasing a length of the drying unit and/or by decreasing the speed of the glass ribbon. Alternatively, the heating time can be decreased by decreasing the length of the drying unit and/or by increasing the speed of the glass ribbon. In some embodiments, the drying unit comprises multiple segments that can be maintained at different temperatures. For example, a first segment is maintained at the first heating temperature and a second segment is maintained at the second heating temperature. Passing the glass ribbon continuously through the drying unit (e.g., through the first segment and subsequently through the second segment) can enable exposing the coupling agent coated region to the first heating temperature and subsequently exposing the coupling agent coated region to the second heating temperature.

In some embodiments, each of the applying step, the heating step, and the winding step is part of a continuous process (e.g., as shown in FIGS. 3-5). Additionally, or alternatively, each of the forming step, the applying step, the heating step, and the winding step is part of a continuous process (e.g., as shown in FIG. 3). In some embodiments, each of the applying step, the heating step, and the winding step is part of a continuous roll-to-roll process (e.g., as shown in FIGS. 4-5). Additionally, or alternatively, each of the unwinding step, the applying step, the heating step, and the winding step is part of a continuous roll-to-roll process (e.g., as shown in FIGS. 4-5).

### EXAMPLES

Various embodiments will be further clarified by the following examples.

### Example 1

A diluted acetic acid was prepared by mixing one part of glacial acetic acid with 9 parts of deionized (DI) water, on a volume basis. An acidified alcohol was prepared by mixing one part of the diluted acetic acid with 50 parts of ethanol, on a volume basis. Coupling agent solutions having various silane concentrations were prepared by mixing 3-acryloxypropyl trimethoxysilane with the acidified alcohol and stirring for 5 min to 10 min.

Various samples were prepared by casting a layer of the coupling agent solution having a thickness of about 13 μm (0.0005 in) wet onto a glass plate having a thickness of about 150 μm. The glass plate with the coupling agent solution was heat treated at 110° C. for 10 min. The glass plate was not cleaned prior to the silane treatment. An ultraviolet (UV) curable coating was cast on the treated glass plate and cured.

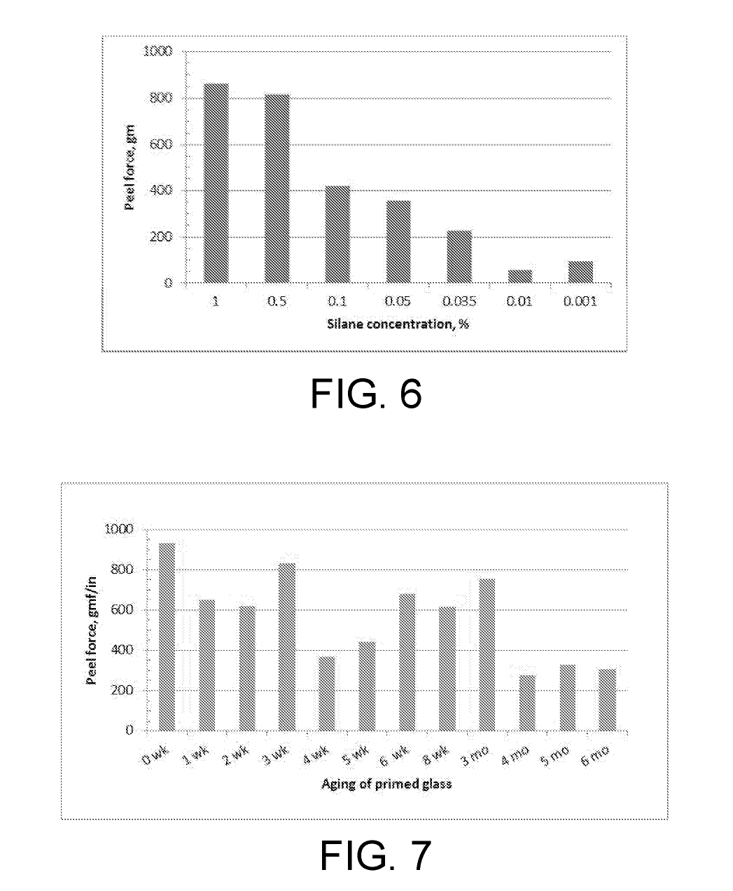

FIG. 6 is a graphical illustration of the peel force of the UV curable coating as a function of silane concentration, on a weight basis. The peel force was measured according to a modified test method derived from the ASTM D3330 Standard Test Method for Peel Adhesion of Pressure-sensitive Tape, Test F. The UV curable coating was cast on the silane treated glass plate at a wet coating thickness of 0.010 in. The coating was cured in a UV curing unit at a dose of 2.2 joule/cm². A 1 in wide adhesive tape with embedded glass fiber (e.g., Scotch 897, commercially available from 3M, Minneapolis, Minn., USA) was placed on top of the cured coating. The cured coating was cut along the edges of the tape and the excess coating was removed from the glass plate. The glass plate was held mechanically on a moveable slide that was connected to a crosshead of a tensile tester so that movement of the slide was in concert with the crosshead. The 1 in wide coating strip with the adhesive tape was peeled back about two inches and mounted on a pair of grippers of the tensile tester to maintain a 90 degree angle between the crosshead and the slide. The slide was moved to peel the adhesive tape and coating strip from the glass plate at a rate of 5 mm/min, and the peel force data was collected at 20 Hz. As shown in FIG. 6, the peel forces were more than 200 g/in at silane concentrations of 0.035% or above.

### Example 2

A sample was prepared by casting a layer of a coupling agent solution onto a glass plate as described in Example 1. The silane concentration of the coupling agent solution was 0.05%. The glass plate with the coupling agent solution was heat treated at 100° C. for 12 s and then subsequently heat treated at 40° C. for 1 min. A UV curable coating was cast on the treated glass plate and cured.

The peel force of the UV curable coating was 688 g/in. The heat treatment used in Example 2 was relatively low temperature and relatively short compared to the heat treatment used in Example 1 (110° C. for 10 min). Thus, Example 2 demonstrates that a relatively low temperature and relatively short heat treatment is capable of yielding a sufficient peel force (e.g., at least about 200 g/in).

### Example 3

Various samples were prepared by wiping a coupling agent solution onto a glass plate having a thickness of about 150 μm. The coupling agent solution was 1% acrylate silane in 95% ethanol. The glass plate with the coupling agent solution was heat treated at 110° C. for 10 min.

The samples were stored in a dark storage condition. Periodically, a sample was removed from storage and coated with a UV curable coating. The UV curable coating had a wet laydown thickness of 0.254 mm (0.01 in) and was cured at 1 J/cm². The coated sample was maintained at ambient temperature (about 25° C.) and 50% relative humidity overnight (about 12 h), and then the peel force of the UV curable coating was measured. FIG. 7 is a graphical illustration of the peel force of the UV curable coating as a function of storage time. The peel force degraded over 6 months from 900 g/in to 300 g/in as shown in FIG. 7. However, the peel force remained significantly higher than that of control samples prepared without silane treatment. The control samples had peel forces of about 4 g/in to about 10 g/in. Thus, Example 3 demonstrates that the silane treatment improves adhesion of the UV curable coating to the glass, even after storing the silane treated glass prior to coating.

### Example 4

Various samples were prepared by casting UV curable coatings on untreated and treated glass plates and curing the coatings.

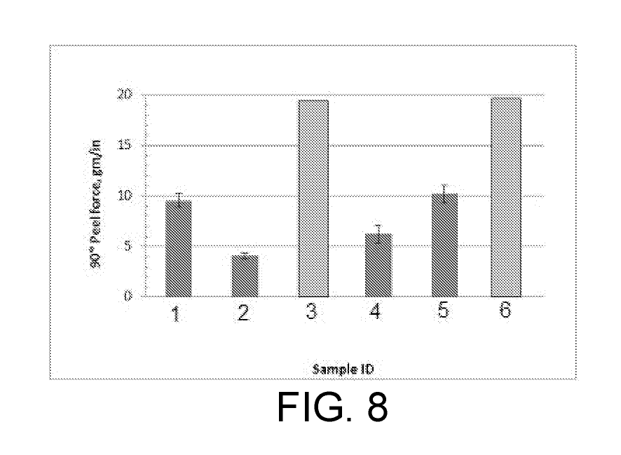

FIG. 8 is a graphical illustration comparing the peel force of the various samples. Samples 1, 2, 4, and 5 were prepared by casting the UV curable coatings on glass plates that were not treated with a coupling agent solution (i.e., untreated glass plates) and curing the coatings. Samples 3 and 6 were prepared by casting the UV curable coatings on glass plates that were treated with a coupling agent solution (i.e., treated glass plates) and curing the coatings. The truncated bars shown for treated samples 3 and 6 indicates that the coating crumbed, indicating a cohesive failure of the coating, instead of delaminating, indicating an adhesive failure between the coating and the glass. Thus, the peel force for treated samples 3 and 6 was too high to measure.

It will be apparent to those skilled in the art that various modifications and variations can be made without departing from the spirit or scope of the invention. Accordingly, the invention is not to be restricted except in light of the attached claims and their equivalents.

1. A method comprising:
applying a coupling agent solution to a major surface of a continuously moving glass ribbon to form a coupling agent coated region of the glass ribbon, the glass ribbon comprising a flexible glass ribbon having a thickness of at most about 300 μm;
heating the coupling agent coated region of the glass ribbon to form a coupling agent treated region of the glass ribbon; and
winding the glass ribbon onto a collection roll.

2. The method of claim 1, wherein each of the applying step, the heating step, and the winding step is part of a continuous process.

3. The method of claim 1, wherein the heating step comprises exposing the coupling agent coated region of the glass ribbon to a heating temperature of about 100° C. to about 120° C. for a heating time of about 5 minutes to about 15 minutes.

4. The method of claim 1, wherein the heating step comprises:
exposing the coupling agent coated region of the glass ribbon to a first heating temperature of about 90° C. to about 110° C. for a first heating time of about 5 seconds to about 30 seconds; and
subsequently exposing the coupling agent coated region of the glass ribbon to a second heating temperature of about 30° C. to about 50° C. for a second heating time of about 45 seconds to about 90 seconds.

5. The method of claim 1, wherein the winding step is performed subsequent to the heating step.

6. The method of claim 1, wherein the winding step is performed prior to the heating step.

7. The method of claim 1, wherein the coupling agent solution comprises a silane component and a solvent.

8. The method of claim 7, wherein the silane component comprises an alkoxysilane.

9. The method of claim 7, wherein the solvent comprises an alcohol.

10. The method of claim 1, wherein the applying step comprises at least one of slot die coating, spray coating, dip coating, vapor deposition, wiping, or doctoring.

11. The method of claim 1, wherein the applying step comprises applying a layer of the coupling agent solution to the major surface of the continuously moving glass ribbon, and a wet thickness of the layer is about 100 μm to about 200 μm.

12. The method of claim 1, further comprising forming the glass ribbon, wherein each of the forming step, the applying step, the heating step, and the winding step is part of a continuous process.

13. The method of claim 1, further comprising unwinding the glass ribbon from a supply roll, wherein each of the unwinding step, the applying step, the heating step, and the winding step is part of a continuous roll-to-roll process.

14. The method of claim 1, further comprising coating at least a portion of the coupling agent treated region of the glass ribbon with a polymeric layer prior to the winding step.

15. The method of claim 14, wherein a peel force of the polymeric layer is at least about 200 gf/in.

16. The method of claim 1, wherein the winding step comprises spacing adjacent windings of the glass ribbon from each other such that the glass ribbon on the collection roll is free of contact between major surfaces of the adjacent windings.

17. The method of claim 15, wherein the method comprises applying an edge tab to an edge region of at least one of the major surface or an opposing major surface of the glass ribbon, and the spacing step comprises positioning the edge tab between the adjacent windings.

18. The method of claim 1, wherein the method is free of a cleaning step prior to the applying step.

19. A method comprising:
passing a glass ribbon continuously through a coating unit to apply a coupling agent solution to a major surface of the glass ribbon and form a coupling agent coated region of the glass ribbon, the glass ribbon comprising a flexible glass ribbon having a thickness of at most about 300 μm;
passing the glass ribbon through a heating unit to heat the coupling agent coated region and form a coupling agent treated region of the glass ribbon; and
winding the glass ribbon onto a collection roll.

20. A glass ribbon comprising:
a thickness of at most about 300 μm; and
a major surface, at least a portion of the major surface comprising a coupling agent treated region,
wherein, upon forming a polymeric layer on the coupling agent treated region at least five months after forming the coupling agent treated region, the polymeric layer comprises a peel force of at least 200 gf/in.

21. The glass ribbon of claim 20, wherein the glass ribbon comprises a rolled glass ribbon.

22. The glass ribbon of claim 21, wherein adjacent windings of the rolled glass ribbon are spaced from each other.

23. The glass ribbon of claim 22, further comprising an edge tab disposed on an edge region of at least one of the major surface or an opposing major surface of the rolled glass ribbon to space the adjacent windings from each other.
